(19) United States
(12) Patent Application Publication
(10) Pub. No.: US 2022/0076518 A1
(43) Pub. Date: Mar. 10, 2022

(54) BLOCKCHAIN-BASED METHOD AND SYSTEM FOR SELECTING WINNER FROM AMONG WEIGHTED CANDIDATES

(71) Applicant: MILLION CIRCLE CO., LTD., Seongnam-si, Gyeonggi-do (KR)

(72) Inventor: Ki-Man BYUN, Seongnam-si (KR)

(73) Assignee: MILLION CIRCLE CO., LTD., Seongnam-si, Gyeonggi-do (KR)

(21) Appl. No.: 17/417,034

(22) PCT Filed: Dec. 20, 2019
(86) PCT No.: PCT/KR2019/018223

§ 371 Date: Jun. 21, 2021

(30) Foreign Application Priority Data
Dec. 21, 2018 (KR) 10-2018-0167488

(51) Int. Cl. G07C 13/00; H04L 9/32; G06F 16/27; G06Q 30/02

(52) U.S. Cl. CPC G07C 13/00; H04L 9/3247; H04L 2209/38; G06Q 30/0267; G06Q 30/0203; G06F 16/27

(57) ABSTRACT

The blockchain-based system for selecting a winner from among weighted candidates comprises: a server comprising secret voting smart contract comprising a ballot, and a plurality of candidates each having a particular weighted value; and a digital wallet having a digital identification and capable of communicating with the server. The secret voting smart contract is coded so as to be suitable for publishing and executing in a blockchain network, and a voter in possession of a digital wallet can, using the digital wallet, access a secret voting smart contract on the server to browse a plurality of candidates and vote by casting a ballot. The weighted value assigned to each candidate is determined on the basis of the level of completion of a task, and of the degree of participation and contribution thereto, the task being of a set type provided by the server. Preferably, a task according to the present invention comprises a series of actions related to an advertising, and the the task is proposed in the form of an advertising and a questionnaire related thereto. A user views a proposed advertising and then completes a task by answering a series of questions on a questionnaire. The series of questions are in the form of a quiz, survey, research, and the like directly and indirectly related to an advertising.

### FIELD OF INVENTION

The present invention relates to a method and system for selecting a winner among candidates with their own weight based on a blockchain, and more particularly to a method and system for selecting at least one winner through voting by users on platforms driven using blockchain technology among candidates with their own weight. More particularly, the present invention relates to a method and system for selecting at least one winner among candidates with their own weight through votes cast for responses based on the blockchain, the responses being collected from the users who have viewed an advertising on their computers or mobile devices and responded a questionnaire given to them.

### BACKGROUND OF INVENTION

For many years, a draw has been practiced as a random selection method to select a winner, to select one to perform a task from among a group of people, or to select a political official from a large group of candidates. Various objects such as straw, pieces of paper, and wood are used as tools for the draw. Recently, it is understood that various types of draw programs are used due to the development of computer programs.

A chronic problem raised in relation to a draw is unfairness. This is because there is a possibility that influence of people involved in the draw exists in any draw method.

### SUMMARY OF INVENTION

### Technical Problem to be Solved

The present invention is to solve such problems in the prior art, and according to the present invention, a method and a system for selecting a winner among candidates having different weights based on a blockchain are provided. The weight applied to each of the candidates may be determined based on participation and contribution of participants (users and consumers) participating in a campaign.

### Technical Solution

According to the present invention, a system for selecting a winner among candidates having a weight based on a blockchain includes a server including a secret ballot smart contract including a plurality of candidates having respective unique weights, and a vote, and a digital wallet including an electronic ID and configured to communicate with the server. The secret ballot smart contract may be deployed in a blockchain network and may be appropriately coded to be executed, and a voter having a digital wallet may access the secret ballot smart contract of the server and may browse the plurality of candidates using the digital wallet, and may cast the vote.

According to an aspect of the present invention, a weight applied to each of candidates for randomly selecting at least one winner by a draw among a plurality of candidates may be determined based on a degree of completion, participation, and contribution of a predetermined type of task provided by the server. The task according to the present invention may be performed by a series of actions related to advertising, and according to an embodiment, the task may be presented in the form of an advertising or a questionnaire related thereto. After viewing the presented advertising, the user may achieve the task by responding to questions recorded in the questionnaire. The series of questions may include a quiz, a survey, or research, which is directly related to advertising.

According to another aspect of the present invention, the task may be provided in one or plural, the plurality of tasks may belong to the same type or category or may belong to different types or categories. For example, some tasks may be quizzes, and some other tasks may be research. Some tasks may be presented in the form of a questionnaire, and other tasks may be configured in the form of execution, such as membership joining including invitation of acquaintances. When there is a plurality of tasks, the weight may be determined within the same type, or may be determined by mixing different types.

According to an aspect of the present invention, random selection of at least one winner by a draw among a plurality of candidates may be determined by voting based on a blockchain. According to embodiments of the present invention, voting may be performed using a smart contract of the Ethereum blockchain.

### Effect of Invention

When electronic voting using a smart contract of the Ethereum blockchain is deployed on the blockchain, various advantages may be obtained. The first advantage may be transparency. The smart contract is filled with very detailed conditions, which are checked by the parties involved in the contract. Accordingly, when the conditions are thoroughly checked and all participants agree on the conditions, the smart contract may become appropriate, and thus, the possibility of later disputes may be removed.

The smart contract is explicitly coded in a detailed format, thus providing accuracy. In the smart contract, data may be encrypted by cryptographic technology, and thus the smart contract may be safe, and reliability may be achieved due to transparency and stability.

### BRIEF DESCRIPTION OF DRAWINGS

FIG. 1 is a system block diagram showing an exemplary network environment for explaining a method of delivering advertisings created by an advertiser to a user through an advertising publisher according to embodiments of the present invention.

FIG. 2 is a diagram showing an example of the case in which an advertising is displayed on a client device in the system environment of FIG. 1 according to embodiments of the present invention, FIG. 2A is a home screen and FIG. 2B is a diagram showing a separate screen for displaying linked content.

FIG. 3 is a conceptual diagram of a system showing an entire procedure of voting for candidates based on blockchain according to an embodiment of the present invention.

FIG. 4A is a diagram showing a method of applying a weight to each candidate according to an embodiment of the present invention, and FIG. 4B is a diagram showing the case in which each candidate is subdivided into three ratings.

FIG. 5 is a diagram showing a method of selecting at least one candidate as a winner by tallying the voting result by voters based on the blockchain.

FIG. 6 is a block diagram showing a method of determining one rating of three ratings of the candidates selected in FIG. 5.

FIG. 7 is a block diagram showing components in the form of a computer for reading commands from a machine (computer) readable medium and executing one or more methods discussed in the present invention according to embodiments of the present invention.

### BEST MODE

Reference will now be made in detail to embodiments, examples of which are illustrated in the accompanying drawings.

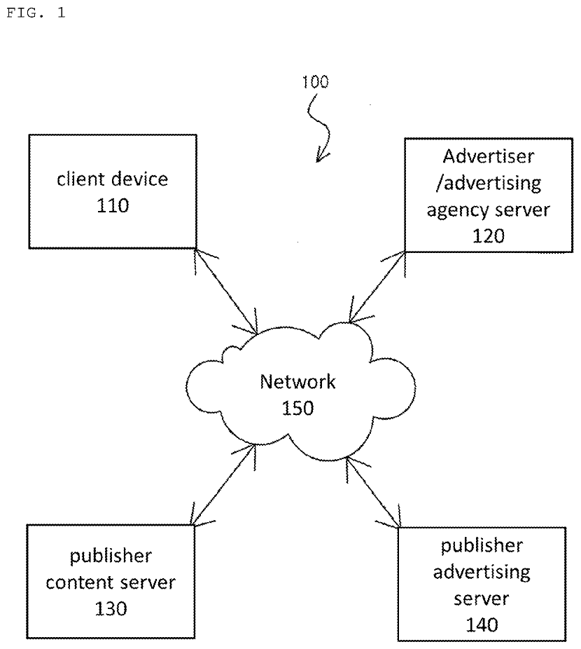

FIG. 1 is a system block diagram showing an exemplary network environment for explaining a method of delivering advertisings created by an advertiser to a user through an advertising publisher according to embodiments of the present invention. A network environment 100 may include a client device 110, a publisher content server 130, and a publisher advertising server 140. When advertising is directly distributed by an advertiser, the network environment 100 may further include an advertiser/agency advertising server 120.

A client device, that is, a user device 110 may include a desktop computer, a lap top computer (called a notebook computer), a tablet computer, a smartphone, and other mobile devices, and devices for receiving and reproducing a stream of video and/or other multimedia content. The client device 110 may include a display or another user interface configured to display content such as processed images, web pages, documents, or video content.

The client device 110 may request content from websites through a network 150 such as the Internet and may receive content from the websites. The network 150 may include a public network (e.g., the Internet), a private network (e.g., a local area network (LAN), or a wide area network (WAN)), a wired network (e.g., an Ethernet network), a wireless network (e.g., a Wi-Fi network), routers, hubs, switches, server computers, and/or a combination thereof.

In some embodiments, a user requests a web page as a search target to the publisher content server 130 through the network 150 using the client device 110, and the publisher content server 130 transmits the requested web page to the client device 110 in response to the request. In this case, various types of advertisings (e.g., banner, pop-up and pop-under, or video ad) are executed and displayed by the publisher advertising server 140 in an advertising space (advertising or ad space) allocated to a web page provided by the publisher content server 130. If the advertiser site distributes advertisings directly or delegate swork to an advertising agency, the advertiser/agency advertising server 120 may display the advertisings on the web page provided by the publisher content server 130.

Most advertisings (including video advertisings) displayed on the client device 110 of the user by the advertising servers 120 and 140 only contain, in short, links to specific web pages of the advertising servers 120 and 140 of a publisher or an agency. For these types of advertisings, when the user clicks an advertising displayed on a screen of the client device 110, an Internet browser of the user connects the client device 110 to a specific web page of the publisher advertising server 140 or the advertiser/agency advertising server 120, and thus the user watches the clicked advertising. Hereinafter, how these processes are performed will be described by picking, as an example, display advertising, more specifically, banner ads, which is one of the representative advertisings among display advertisings.

The display advertising is, in short, advertising on a website, which is provided in a variety of formats. The display advertising includes various items such as text, an image, flash, video, and audio. The display advertising is an online form of advertising in which a promotional message of a company (advertiser) is displayed on a third-party site such as an advertising publisher or social network or on a search engine result page.

Banner advertising is one of the representative forms of display advertising. At one time, banner advertising was mainly most commonly used as in display advertising, but as with disregard of banner advertising by users who are fed up with the flood of advertisings, an click-through rate has become reduced, and so that the effectiveness of banner advertising is being questioned. However, banner advertising is still positioned as a major medium in the advertising market while maintaining its ripple effect. Above all, the banner advertising is a suitable example for understanding an advertising system related to FIG. 1 of the present invention.

The banner advertising is, in short, a special type of hypertext link. A basic role of a text link is that, when a user clicks a portion of a text, a series of HTML codes instructs a web server to fetch a specific web page. The banner advertising is essentially the same as a text link, except that the banner advertising is displayed as a box containing graphics (usually involving text elements) and sometimes animations instead of text. Needless to say, the banner advertising may further include files of video or audio, etc.

When a user surfs the web through a web browser driven on the client device 110, a large number of advertisings is posted, by the advertising servers 140 and 120, on a web page or a series of web pages provided from the publisher content server 130. These advertisings displayed on web pages provided by the publisher content server 130 may be displayed on a search engine result page in a web browser as a result of a user's inputting a search term, or when a user enters a web address or URL, the advertisings may be displayed as on a new tab or window within the web browser. As described above, the advertisings displayed on the screen of the client device 110 by entering a search term or a web address, in short, hypertext links. When a user clicks one of the banner advertisings that attracts his or her interest among advertisings displayed on the client device 110, the web browser connects the client device 110 to the web server (140 or 120 in the embodiment), on which the clicked banner advertising is stored, to request the corresponding web page, and accordingly, the user can watch the advertising clicked by himself or herself.

Through these processes, the web browser of the client device 110 fetches a desired web page from the web servers (120, 130, and 140 in the embodiment) through the network 150 and displays the web page on the screen of the client device 110, that is, the browser.

The web browser also interprets a set of HTML tags contained in the web page and displays the web page on a screen of the client device 110 in a way in which a web page creator wants the web page to be displayed. The web page has text and a HTML tag which describes how the text should be formatted when the browser displays the page on the screen. Tags are instructions instructing what shape the web page needs to be taken when the web browser displays the web page. The tags instruct the web browser to perform a task such as changes of font sizes or colors, or arrangement of objects in columns. In other words, the web browser interprets the tags in order to determine how the text needs to be formatted on a screen.

So far, of how users are able to view various types of advertisings including banner advertisings on the client device 110 through a browser, that is, a web browser, have been described.

Needless to say, unlike a desktop or laptop computer, advertisings may also be displayed through various apps, which are driven on mobile devices and provided by an advertising publisher operating the publisher content server 130 or other developers. For example, an operator of the publisher content server 130 may win advertisings from many advertisers and may distribute advertisings through apps installed in the mobile client device 110. In the case of distribution of advertisings through an app driven in a mobile device, the advertisings may be displayed on the client device 110 through a mobile browser, which is a sort of web browser suitably designed for a mobile device such as a smartphone or PDA.

Even in the case of advertising using mobile applications, advertisings displayed on web pages provided by the publisher content server 130 may include only minimum information including hyperlinks to a specific advertising web page stored on the publisher advertising server 140 or the advertiser/agency advertising server 120, as described above. Accordingly, when an advertising (e.g., an advertising displayed in an advertising space or a popup advertising) in a web page displayed on the mobile browser of the client device 110 is clicked, a specific advertising web page on the publisher advertising server 140 or the advertiser/agency advertising server 120 is reconnected. Through these processes, the user may watch the advertising selected by himself or herself.

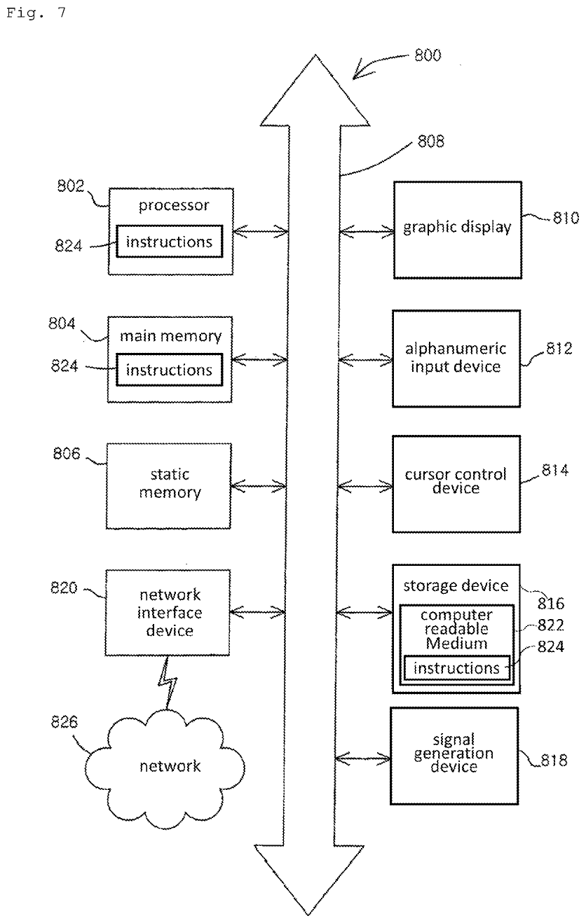

The machines, devices, or databases shown in FIG. 1 may be all realized by configuring or programming a general-purpose computer to become a special-purpose computer by software. A computer system capable of implementing one or more of the methods described herein will be described below with respect to FIG. 7. Any two or more of the machines shown in FIG. 1 may be combined into one machine, and functions described in one machine may be subdivided into several machines.

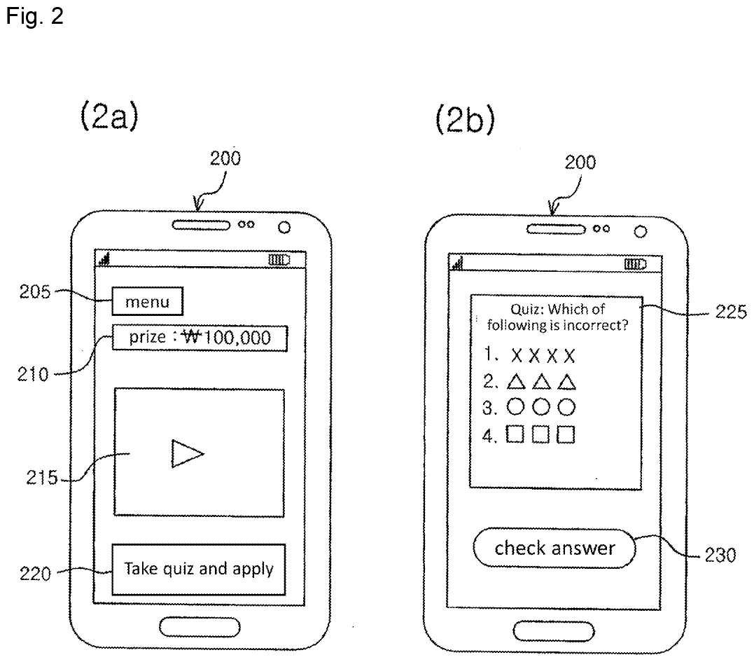

FIG. 2 is a diagram showing an example of the case in which an advertising is displayed on a client device in the system environment of FIG. 1 according to embodiments of the present invention. FIG. 2A is a home screen and FIG. 2B is a diagram showing a separate screen on which content linked through a user interface on a home screen is displayed. In the example of FIG. 2, a smartphone 200 among mobile devices has been selected as an example of the client device 110. When the user clicks or touches an application provided by an advertising publisher among icons displayed on the home screen of the client device, that is, the smartphone 200, the home screen of the app shown in FIG. 2A is displayed on the smartphone 200. The home screen of the app includes buttons such as an amounts of a prize 210 and a button 220 for taking a quiz and applying for, and an advertising 215 to be displayed (e.g., a video advertising) placed in the center of the screen. In addition, the app is configured, when a menu button 205 is touched, to be able to search explanations about the operations and functions of the application, ongoing campaigns, and rewards given when participating in the questionnaire.

When the user presses a play button of the advertising 215, the advertising content is properly displayed on the screen of the smartphone 200 through the processes described above with reference to FIG. 1. When the user pushes the button for taking a quiz and applying for after watching the advertising, the content linked by the navigation is displayed on a next screen of the smartphone 200 (FIG. 2B). When the user pushes a button for checking correct answers 230after solving a quiz 225 presented in the form of a questionnaire the correct answer or not I displayed on the screen of the smartphone 200. When the response to the quiz is correct, it I transmitted to and stored on the response management server (not shown) of the advertising publisher from the client device 110 (here, the smartphone 200) through the network 150. Here, the response management function may be configured by way of hardware or programmed to be processed by the publisher content server 130 or the publisher advertising server 140 without using a separate server.

In embodiments of the present invention, the task may be presented, for example, in the form of a questionnaire relating to advertising and/or promotion. The questionnaire may include quizzes directly or indirectly related to advertisings and/or public relations, research related to products or services, and surveys, and may also include a combination thereof. Therefore, when a user who has viewed an advertising transmits a response to a response management server of a publisher for a quiz or research, the response management server collects, categorizes, and stores responses from users, and then, the response management server selects at least one winner by a draw from among the responses after an event campaign such as an advertising finishes. These campaigns may be repeatedly implemented and managed as rounds with a regular cycle.

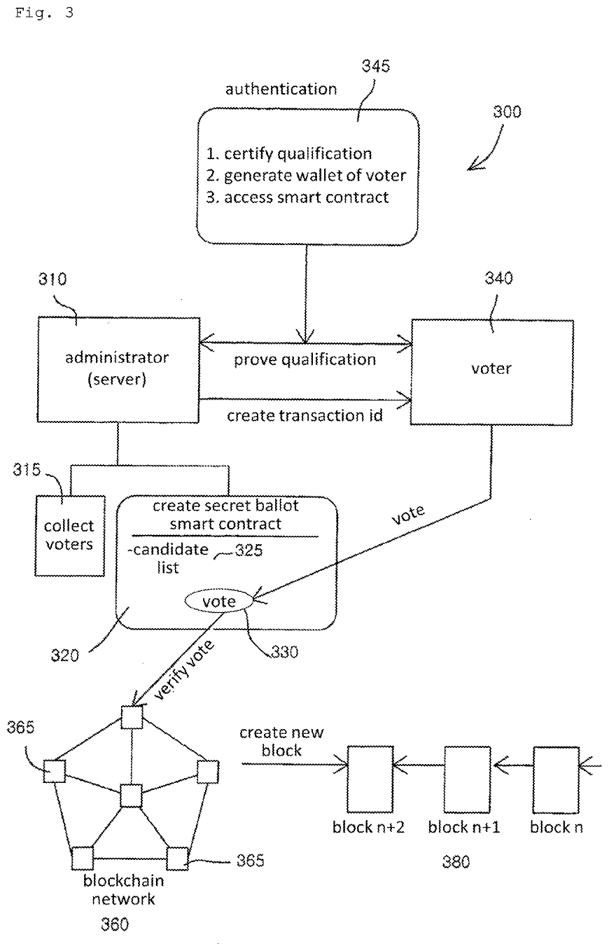

FIG. 3 is a conceptual diagram of a system showing an entire procedure of voting for or against candidates based on blockchain according to an embodiment of the present invention.

Blockchain: A blockchain is an ever-growing list of records, called blocks, which are linked together using cryptography. Each block has a cryptographic hash of a previous block, a timestamp, and transaction data represented as a Merkle tree hash of the previous block. The blockchain keeps a record of all data exchanges, which is called a ledger, and each data exchange is a transaction. All transactions are verified and added to the ledger as blocks. A blockchain is defined as an open decentralized ledger that is capable of recording transactions between parties in a verifiable and durable way. In order to be used as a decentralized ledger, the blockchain is managed by a peer-to-peer network. Once written, data within a block is not capable of being changed retrospectively without changing all subsequent blocks. The blockchain was introduced by Satoshi Nakamoto in 2008 as the public transaction ledger for the crypto currency Bitcoin, which is the first digital currency to prevent double-spending without the need for a trusted authority or central server.

The basic concept to keep in mind in blockchain is a cryptographic key, that is, a public key and a private key. Your public key allows others to identify you and access you. The private key is used with the public key to represent digital identity and authorize actions to be digitally signed and authenticated. In the cryptocurrency world, the public key represents a wallet address, and the private key transfers or withdraws digital assets such as cryptocurrency or authenticates other actions.

All transactions on the blockchain need to be verified (e.g., whether a transaction is malicious, or whether a transaction corresponds to double spending), and need-to go through a consensus process in order to be added to the existing blockchain as a new block. A consensus algorithm is closely related to a processing speed of the blockchain, and the Bitcoin blockchain uses a Proof-of-Work algorithm, while the Ethereum uses a Proof-of-Stake algorithm. There are currently three types of blockchain of a public blockchain, a private blockchain, and a consortium blockchain. The public blockchain does not have any access restrictions, and anyone connected to the Internet can create transactions and become a validator. These types of blockchain are mostly used in cryptocurrency (Bitcoin and Ethereum). Under the private blockchain, one cannot participate in it and become a validator unless permissioned by a network administrator. This type is a kind of compromise suggestion and takes advantage of blockchain technology without losing autonomy and without the risk of exposing sensitive data. The consortium blockchain is permissive, but instead of control by a single organization, multiple companies are separately capable of operating a node on the blockchain. The administrator of the consortium blockchain limits reading rights of users and allows only limited trusted nodes to execute the consensus protocol.

Smart contracts: The concept of a smart contract was introduced in 1994 by legal scholar and cryptographer Nick Szabo. He concluded that decentralized ledgers could be used as self-executable contracts, which later came to be called smart contracts. The idea of smart contracts has existed for a long time, but involvement of trusted third parties could not be completely ruled out. With introduction of the blockchain, problems related to third-party intervention (e.g., security issues, deceptive behaviors, or increased transaction costs) have been completely resolved. The smart contract is one of the most successful applications of blockchain technology. Ethereum is the most popular blockchain platform for creating a smart contract. The smart contract may be applied in different industries such as e-commerce, real estate, and e-voting. A smart contract is a set of computer codes between two or more parties driven on the blockchain and includes a set of rules agreed upon by involved parties. By execution, when this set of predefined rules is satisfied, the smart contract is autonomously executed to produce results. By facilitating, validating, and executing the contract with the underlying codes, decentralized auto-execution can be obtainable. In other words, the smart contract is automatically executable lines of code stored in the blockchain having predefined rules. When these rules are satisfied, the code is autonomously executed to produce the result.

Embodiments of the present invention: According to embodiments of the present invention, a method and system for selecting one or more weighted candidates based on the blockchain may be capable of using all three types of blockchains. However, the most desirable one would be the consortium blockchain, which is permissioned but allows multiple nodes to participate and interact (communicate)so as to overcome the disadvantages of being controlled by a single organization. Above all, the administrator of the consortium blockchain can limit the vested right and accessibility of users so that a system can be designed in which only trusted and limited nodes are able to participate in the consensus process.

Which consensus algorithm is used relates closely to the efficiency and scalability of the blockchain. Bitcoin uses proof-of-work, which consumes huge amounts of computer resources and electricity to prove transactions and blocks. In contrast, the proof-of-stake algorithm chooses to give the blockchain participants who have the largest stake the right to prove blocks. Currently, Ethereum adopts this method. The underlying assumption of the proof-of-stake is that the greater a user's stake, the greater his or her understanding of system maintenance. However, the biggest weakness of proof-of-stake is that even if the size of stake is the same, different owners may evaluate differently. Let us assume an example in which Mr. Kim has early accepted blockchain technology and has a large portfolio of digital assets, but Mr. Park is a beginner and is mining only recently created tokens. Further assume that both of them own the same amounts of stake as 1,000 MC, tokens of Milcle which is a virtual network. Separately, it may be considered that Mr. Kim and Mr. Park share the same interest in the success of Milcle. However, when considering their other assets, 1,000 MC may occupy only 1% of the total assets for Mr. Kim, while 50% for Mr. Park. A power of authority (POA) algorithm is a variant of proof-of-stake in which identity of a validator functions as a stake instead of a stake of monetary value. In the case of proof of authority, a user is able to gain the authority to prove transactions by maintaining a very transparent reputation.

According to embodiments of the present invention, a method and system for selecting one or more weighted candidates based on the blockchain uses electronic voting based on a smart contract the Ethereum blockchain. When the electronic voting using the smart contract is deployed on the blockchain, various advantages can be obtained. Among these advantages, transparency (which has always been a controversial subject in selection of a winner by a draw), exclusion of potential dispute, stability, and reliability due to transparency and stability may be listed.

A smart contract is deployed and executed in an Ethereum environment. The smart contract can be deployed, stored, and executed in an Ethereum virtual machine, and can also store data. The stored data can be used to record information, a fact, balance, and any other information necessary to realize logic of real contracts. There are many authoring tools for a smart contract, including Visual Studio, but the easiest and fastest way to develop a smart contract is to use a browser-based tool known as Remix. The remix provides a rich and integrated development environment for authoring, developing, deploying, and dispute resolution of the smart contract written using the Solidity language on the browser.

Referring to FIG. 3, there three types of actor's roles in a system 300 for voting based on a smart contract on the Ethereum blockchain: administrator, voter, and validator.

The administrator, i.e., a server 310, initiates voting, configures secret (bearer) voting, registers voters, determines an election period, and determines permission nodes.

Each voter 340 authenticates them to prove their eligibility of voting, creates a voter wallet, accesses a smart contract to vote (345), and observes election results.

When the administrator 310 initiates voting, a secret ballot smart contract 320 is deployed on a blockchain network 360, and thus, validators, i.e., validator nodes 365 (which are proof-of-stake or proof-of-authority nodes selected by the administrator among nodes included in the blockchain network 360) are allowed to access the secret ballot smart contract. When the voters 340 vote through the secret ballot smart contract 320, the validator nodes 365 validate voting data and when a consensus is reached for all votes, the voting data is completely ready to be added to the blockchain as a new block.

Voting process: The main activities that occur during an election process are as follows.

Election start: The administrator(server) 310 initiates a secret ballot using a decentralized app (dApp).Through the dApp, the administrator 310 interacts, i.e., communicates with the secret ballot smart contract 320. The administrator 310 defines a candidate list 325 and a vote 330 in the secret ballot smart contract 320, and deploys the secret ballot smart contract 320 on the blockchain network 360. When voting is initiated, each of the validator nodes 365 is given allowance to interact with the secret ballot smart contract 320. The secret ballot smart contract 320 is appropriately coded to be executed by a computing device, and deployed and executed on the Ethereum blockchain.

Voter registration: When voting is initiated, the administrator 310 needs to define a list of eligible voters. According to embodiments of the present invention, an appropriate number of members may be registered as the voter 340 by selecting some, under their own consents, among the members registered in the administrator server 310, e.g., a member management server (not shown, refer to FIG. 1) (345). Once qualification of the voter 340 is verified by the administrator (server) 310, the administrator (server) 310 generates an electronic ID (secret ballot ID) and a public key of the administrator server 310 and sends the generated electronic ID and public key to the verified voter 340 (345). A corresponding digital wallet is created for each of eligible voters 340 and 345 (345), and the digital wallet needs to be unique to each voter.

Vote transaction: Wen voting, the individual voter 340 interacts (communicates) with the secret ballot smart contract 320. The smart contract 320 communicates with the blockchain network 360 through the validator nodes 365 of a region in which the voter is located, and when consensus is reached among most of the validator nodes 365, the validator nodes 365 of the region in which the voter is located attaches the vote 330 to the blockchain. The eligible voters 340 and 345 can vote using the validator nodes 365 in their area through a digital wallet. In order for the voter 340to authenticate themselves, the voter 340 needs to present a valid electronic ID to the validator nodes 365. If authentication is successful, the secret ballot smart contract 320 is displayed, and the voter 340 determines a candidate to vote for from among candidates recorded in the secret ballot smart contract 320 (viewing of candidates). Then, in order to vote, the voter 340 input the digital ID a gin to receive confirmation, and then digitally signs his or her vote 330.

After the voter 340 signs his or her vote 330, data of the vote 330 is verified by the validator nodes 365, which is the very one the voter 340 had communicated with through the secret ballot smart contract 320, and then the data of the vote 330 is widely spread to the blockchain network 360 to be validated by the majority of validator nodes 365. If consensus on the data of the vote 330 is achieved by the majority of validator nodes 365, consensus for a specific vote is reached. Then, the user (voter) 340 receives a transaction ID for a transaction corresponding to his or her vote 330, and the voter 340 can verify the vote 330 he or she has cast using the transaction ID. Each transaction in the secret ballot smart contract 320 keeps information about a voted candidate (i.e. a candidate who the voter has voted for), and the location of the vote 330. Once the vote has been casted and verification has been completed, the secret ballot smart contract 320 executes a function of adding the vote casted to the candidate. When the voter 340 votes, a wallet weight of the voter is reduced by “1”, and thus the voter is not capable of voting more than once.

Tallying: The secret ballot smart contract 320 has a tallying function, and thus votes can be tallied in a smart contract. After voting, the final result of the smart contract 320 is disclosed.

Blockchain addition: All transactions are included in the block after verification, and widely spread to the blockchain network 360, for a consensus process. When consensus is reached by the validator nodes 365, the block is added to the blockchain 380 as a new block.

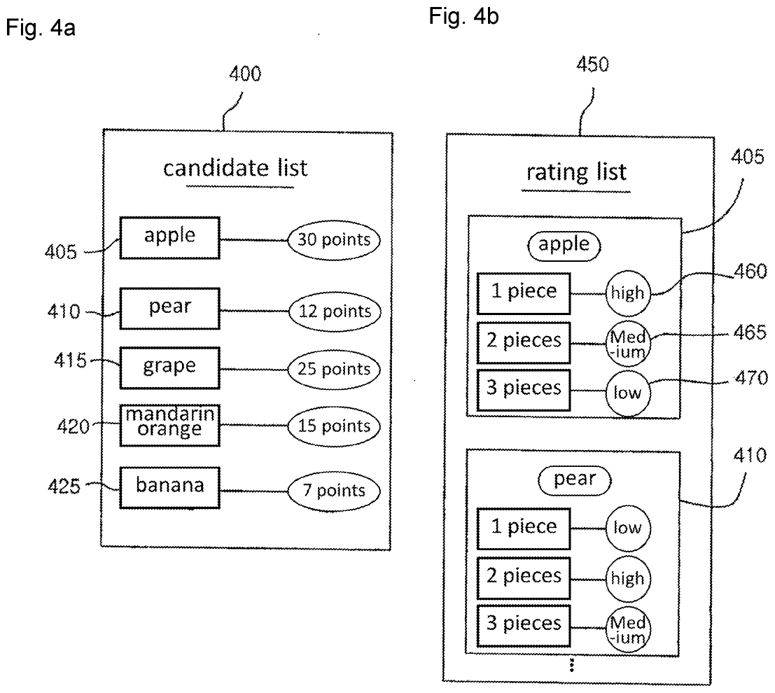

FIG. 4A is a diagram showing a method of applying a weight to each candidate according to an embodiment of the present invention. FIG. 4B is a diagram showing the case in which each candidate is subdivided into three ratings. A candidate list 400 includes, for example, five candidates of an apple 405, a pear 410, a grape 415, a mandarin orange 420, and a banana 425, and a different weight (e.g., 30 points for an apple, 12 points for a pear, etc.) that is unique to each candidate is applied to each candidate. The candidates are randomly arranged regardless of their weight. Here, the candidate means a concept related to completion of a task, not a user directly selected by voting of the voters 340 (precisely, referring to FIGS. 1 and 2, a user selected from among the responded users to a questionnaire among the users of the client devices 110 and 200. In other words, referring to both FIGS. 1 and 2, in exemplary embodiments of the present invention, a task is given to the user in the form of a questionnaire after viewing an advertising, and here the task may relate to only one advertising or to multiple advertisings. Even if tasks are related to one advertising (e.g., a questionnaire), the tasks may have different properties, in which, for example, items of the questionnaire may be the mixture of a quiz, research, and a survey. Accordingly, the user can arbitrarily respond to two or more advertisings displayed on his or her client device 110 and 200, together with respective tasks related to the two or more advertisings, that is, two or more questionnaires. One user may respond to only one task, e.g., a quiz, while another user may respond to some tasks, and still another user may respond to all tasks (the entire questionnaire).

The user may contribute by performing a task completely different from the questionnaire format, for example, events such as membership joining in response to invitation of acquaintances or content creation by participation of a user.

As such, according to embodiments of the present invention, a candidate, on one hand, can be measured by the number of tasks achieved, that is, the number of responses to a quiz or research presented in the questionnaire. This may be treated as being related to the completion of a task.

On the other hand, a task such as membership joining may be classified into types according to the contribution to an ecosystem implemented in the present invention. Accordingly, according to embodiments of the present invention, candidates relates to “grouping” or “category”, resulting from combining the completion of the task and the contribution to the ecosystem.

Accordingly, in FIG. 4A, the apple candidate 405 has the greatest weight of 30 points, and the grape candidate 415 has the weight of 25 points, which means that the sum of the degrees of completion and contribution is 30 points and 25 points, respectively, for the apple candidate 405 and the grape candidate 415, respectively. In other words, respondents (responses) with a weight of 30 points belongs to the apple candidate 405, and respondents (responses) with a weight of 25 points belongs to the grape candidate 415.

Referring to FIG. 4B, when any one candidate is selected from among candidates as explained with reference toin FIG. 4A, the following processes for selecting one of three ratings of high, medium, and low are explained among the selected candidates. As described above, this is because the concept of a candidate relates to grouping or a category. That is, when voting is conducted for the candidate list 400 presented in FIG. 4A, and as a result, when a one candidate is selected, it is necessary to select a winner again among a large number of respondents (responses) because the large number of respondents (responses) belong to the category of the candidate. Accordingly, the voting for a rating list 450 presented in FIG. is performed with a time gap after voting for the candidate list 400 of FIG. 4A has been performed and at least one candidate has been determined from the candidate list 400.

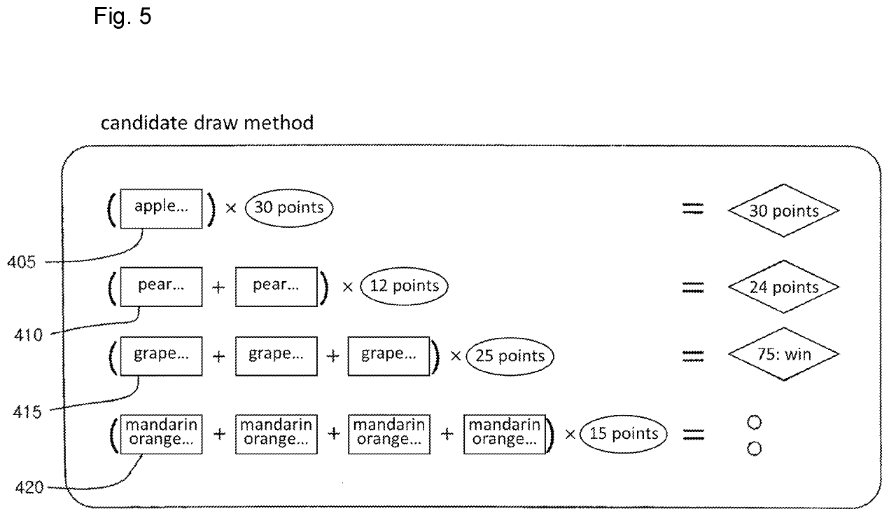

FIG. 5 is a diagram showing a method of selecting at least one candidate as a winner by tallying the result voted by voters based on the blockchain. There is shown the tally result of casted ballots by the voters 340.The apple candidate 405 with the largest weight of 30 points, won only 1 vote, and thus the sum may be is 30. The pear candidate 410 with the weight of 12 points won 2, resulting in 24 points, while the grape candidate 415 with the weight of 25 points won 3 votes, obtaining a total score of 75 points. Compared to the remaining candidates, the grape candidate 415 has the highest total score, and thus the grape candidate 415 is selected as a final winner.

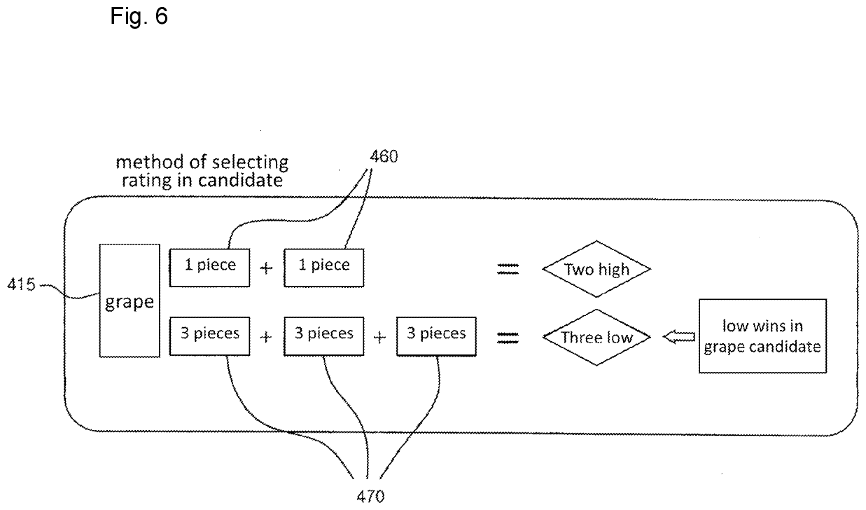

FIG. 6 is a block diagram showing a method of determining one rating of three ratings of the candidates selected in FIG. 5. As a result of having conducted a rating vote for the grape candidate 415 who was selected as explained referring to FIG. 5, the high ratings 460 won two, while the low rating 470 won three. And thus, the low rating 470 of the grape candidate 415 win the final winner.

FIG. 7 is a block diagram showing components in the form of a computer for reading commands from a machine (computer) readable medium and executing one or more methods discussed in the present invention according to embodiments of the present invention. FIG. 7 schematically illustrates a machine in the form of an exemplary computer system, in which instructions 824 (e.g., software) that allows the machine 800 to execute any one or more of the methods discussed here can be executed. In alternative embodiments, the machine 800 can operate as an independent device or can be connected (e.g., networking) to other machines on a LAN, intranet, extranet or Internet. The machine 800 can operate as a server or a client machine in a server-client network environment, or as a peer machine in a peer-to-peer (or decentralized type) network environment. The machine 800 may be a server computer, a client computer, a personal computer (PC), a tablet computer, a set-top box (STB), a personal digital assistant (PDA), a cellular phone, a web appliance, a network router, a switch or a bridge, or any machine capable of (sequentially or otherwise) executing a set of instructions specifying actions to be taken by a corresponding machine. Also, although only a single machine is shown, the term “machine” should be considered as includes any combination of machines that individually or jointly execute the instructions 824 to perform any one or more of the methodologies discussed herein.

The machine 800 includes a processor 802, a main memory 804 (e.g., a read-only memory (ROM), a flash memory, a synchronous dynamic random access memory (DRAM), or a dynamic random access memory (DRAM) such as a Rambus DRAM (RDRAM)), and a static memory 806 (e.g., a flash memory or a static random access memory (SRAM)), which are configured to communicate with each other via a bus 808.

The processor 802 denotes one or more general-purpose processing units such as a microprocessor, or a central processing unit. In detail, the processor 802 may be a complex instruction set computing (CISC) microprocessor, a reduced instruction set computing (RISC) microprocessor, a very long instruction word (VLIW) microprocessor, other processors for embodying instructions sets, or a combination of sets of instructions. The processor 802 may also be one or more special purpose processing devices such as an application specific integrated circuit (ASIC) circuit, a field programmable gate array (FPGA), a digital signal processor (DSP), or a network processor. The processor 802 is configured to execute the commands 824 to perform the operations and steps discussed herein.

The machine 800 further includes a graphic display 810 (e.g., a plasma display panel (PDP), an LED display, or an LCD). The machine 800 also includes an alphanumeric input device 812 (e.g., a keyboard), a cursor control device 814 (e.g., a mouse, a touchpad, a joystick, or other pointing devices), a storage device 816, a signal generation device 818 (e.g., a speaker), and a network interface device 820.

The storage device 816 may include a machine (computer) readable storage medium 822 for storing the instructions 824 (e.g., software) embodying any one or more of the methodologies or functions discussed herein. The instructions 824 can also reside completely or at least partially in the main memory 804 and/or in the processor 802 (e.g., in a cache memory of the processor) while the instructions are being executed by the machine 800, and thus the main memory 804 and the processor 802 also constitutes a machine-readable medium. The instructions 824 can be further transmitted or received through a network 826 via the network interface device 820.

Although the machine-readable storage medium 822 is shown as a single medium in an exemplary embodiment, the term “machine (computer)-readable storage medium” should be considered as including a single medium or multiple media for storing a set of one or more instructions (e.g., centralized or decentralized database, and/or associated caches and servers). The term “machine-readable storage medium” should be also treated as including any medium capable of storing, encoding, or conveying a set of instructions executed by a machine (e.g., the machine 800), and the instructions, when executed by one or more processors (e.g., the processor 802) of a machine, the allows the machine to execute any one or more of the methodologies described herein. Accordingly, the “computer-readable storage medium” includes a solid-state memory, an optical medium, and a magnetic medium, but is not limited thereto.

The present invention is not limited to the embodiments disclosed above, but may be embodied in various different forms, and these embodiments are provided so that this disclosure will be thorough and complete, and will fully convey the concept of the present invention to those skilled in the art, and the scope of the present invention is defined by the claims. Like reference numerals refer to like elements throughout.

Unless otherwise defined, all terms including technical and scientific terms used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is for the purpose of describing particular embodiments only and is not intended to be limiting of the exemplary embodiments. Singular expressions in the present specification include the plural expressions unless clearly specified otherwise in context.

1. A system for voting for candidates with their own weights based on a blockchain, comprising:
a server including a processor; and
a memory for storing executable instruction sand for performing operations when executed by the processor,
wherein the operations include:
preparing a secret ballot smart contract that is appropriately coded to be executed by computing devices and is deployed and executed on a blockchain network, the secret ballot smart contract including a candidate list including a plurality of candidates with their own unique weights, respectively, and a vote to be cast by a digital signature of a voter;
defining a list of the voters, each voter including his or her own unique digital wallets, the digital wallet including an electronic ID and a public key of the server, and each of the voters casting the vote through the smart contract deployed on the blockchain network; and
selecting validator nodes, wherein each of the validator nodes is capable of accessing the smart contract through the blockchain network, wherein a validator node having communicated with any voter through the blockchain network verifies the vote cast for as a vote transaction and widely spreads the vote cast for through the blockchain network for verification of other validator nodes when the very any voter has cast the vote through the smart contract, wherein each of the validator nodes allows the verified votes cast for between the validator nodes among votes cast by the voters to be included in a block, and each of the validator nodes performs consensus on a block including the verified votes cast according to a consensus algorithm between the validator nodes in order to add a block having reached consensus to a blockchain as a new block.

2. The system according to claim 1, wherein the respective weights of the plurality of candidates are determined by a number of responses made through a client device with respect to at least one questionnaire task presented by the server.

3. The system according to claim 2, wherein the respective weights of the plurality of candidates further include classification based on participation in an event type task including membership joining in response to invitation of acquaintances or content creation, the event type task taking place by the server.

4. The system according to claim 1, wherein the operations further include:
presenting, by each of the voters, the electronic ID to one of the validator nodes through the blockchain network for casting the vote;
Browsing the plurality of candidates of the secret ballot smart contract with success in authentication by presenting the electronic ID; and
casting the vote.

5. The system according to claim 1, wherein the list of the voters is defined by an appropriate number of members selected, under their own content, from among members registered in the server.

6. The system according to claim 1, wherein the consensus algorithm is proof-of-stake.

7. The system according to claim 1, wherein the operations further include:
calculating a score of each of the candidates by multiplying the unique weight of each of the candidates and a number of votes obtained by each of the candidates, as the voters vote; and
determining at least one winning candidate according to a high score ranking for the scores obtained by each of the candidates.

8. A system for voting for candidates having weights based on a blockchain, comprising:
a server including a processor; and
a memory configured to store executable commands for performing operations when being executed by the processor, wherein the operations includes:
preparing a secret ballot smart contract that is appropriately coded to be executed in computing devices and is deployed and executed, the secret ballot smart contract including a candidate list including a plurality of candidates having unique weights, respectively, and a vote cast by a digital signature of a voter;
preparing a rating vote smart contract that is appropriately coded to be executed in computing devices and is deployed and executed in a blockchain network, the rating vote smart contract including a rating list for classifying each of the plurality of candidates into a plurality of ratings, and a rating vote to be cast by a digital signature of a voter;
determining before and after voting of the secret ballot smart contract and the rating vote smart contract, wherein at least one candidate is determined by casting the vote of the secret ballot smart contract, and then voting for the rating vote of the rating vote smart contract is performed on one or more determined candidates;
defining a list of voters, each of the voters including a unique digital wallet, the digital wallet including an electronic ID and a public key of the server, and each of the voters casting the vote and the rating vote through the secret ballot smart contract and the rating vote smart contract that are deployed in the blockchain network; and
selecting validator nodes, wherein each of the validator nodes is capable of accessing the secret ballot smart contract and the rating vote smart contract through the blockchain network , wherein a validator node having communicated with any voter through the blockchain network verifies the vote cast for or the rating vote cast for as a vote transaction and widely spreads the vote cast for or the rating vote cast for through the blockchain network for verifying the vote cast for or the rating vote cast for as a vote transaction when the very any voter has cast the vote or the rating vote through the secret ballot smart contract or the rating vote smart contract, wherein each of the validator nodes allows the verified votes cast for or the verified rating vote cast for between the validator nodes among votes or rating votes that have been voted for by the voters to be included in. a block, and each of the validator nodes performs consensus on a block including the verified votes cast for or the verified rating vote cast for according to a consensus algorithm between. the validator nodes in order to add a block having reached consensus to a blockchain as a new block.

9. The system of claim 8, wherein respective weights of the plurality of candidates are determines by a number of responses through a client device with respect to at least one questionnaire task proposed by the server.

10. The system according to claim 8, wherein. respective weights of the plurality of candidates are determined by a number of responses through a client device with. respect to at least one questionnaire task proposed by the server.

11. The system according to claim 8, wherein the operations include:
calculating a score of each of the candidates by multiplying a unique weight of each of the candidates by a number of votes obtained by each of the candidates as the voters vote; and
determining at least one winning candidate according to a high score ranking for the scores obtained by each of the candidates.

12. A method performed by a server including a processor, the method comprising:
preparing a secret ballot smart contract that is appropriately coded to be executed in computing devices and is deployed and executed on a blockchain network, the secret ballot smart contract including a candidate list including a plurality of candidates having unique weights, respectively, and a vote cast by a digital signature of a voter;
defining a list of the voters, the voters including unique digital wallets, respectively, the digital wallet including an electronic ID and a public key of the server, and each of the voters casts the vote through the smart contract deployed on the blockchain network; and
selecting validator nodes, wherein each of the validator nodes is capable of accessing the smart contract through the blockchain network, a validator node communicating with any voter through the blockchain network verifies the cast vote and widely spreads the cast vote through the blockchain network for verification of other validator nodes when any voter casts the vote through the smart contract, each of the validator nodes is included in the verified cast vote between the validator nodes among votes cast by the voters, and each of the validator nodes performs consensus on a block including the verified cast votes using a consensus algorithm between the validator nodes for adding a block reaching consensus as a new block to a blockchain.

13. The method according to claim 12, wherein respective weights of the plurality of candidates are determines by a number of responses through a client device with respect to at least one questionnaire task presented by the server.

14. The method according to claim 13, wherein the respective weights of the plurality of candidates further include classification based on participation in an event type task including membership registration in response to invitation of acquaintances or content creation by the server.

15. The method according to claim 12, wherein the list of the voters is defined by including an appropriate number of members obtaining content from among members registered in the server.

16. The method according to claim 12, wherein the consensus algorithm is proof-of-stake.

17. The method according to claim 12, further comprising:
calculating a score of each of the candidates by multiplying a unique weight of each of the candidates by a number of votes obtained by each of the candidates as the voters vote; and
determining at least one winning candidate according to a high score ranking for the scores obtained by each of the candidates.

18. A method performed by a server including a processor, the method comprising:
preparing a secret ballot smart contract that is appropriately coded to be executed by computing devices and is deployed and executed, the secret ballot smart contract including candidate list including a plurality of candidates having unique weights, respectively, and a vote cast by a digital signature of a voter;
preparing a rating vote smart contract that is appropriately coded to be executed in computing devices and is deployed and executed on a blockchain network, including a rating list for classifying each of the plurality of candidates into a plurality of ratings, and a rating vote cast by a digital signature of a voter;
determining before and after voting of the secret ballot smart contract and the rating vote smart contract, wherein at least one candidate is determined by casting the vote of the secret ballot smart contract, and then voting for the rating vote of the rating vote smart contract is performed on one or more determined candidates;
defining a list of voters, each of the voters including a unique digital wallet, the digital wallet including an electronic ID and a public key of the server, and each of the voters casting the vote and the rating vote through the secret ballot smart contract and the rating vote smart contract that are deployed on the blockchain network; and
selecting validator nodes, wherein each of the validator nodes is capable of accessing the secret ballot smart contract and the rating vote smart contract through the blockchain network, a validator node communicating with any voter through the blockchain network verifies the cast vote or the rating vote as a vote transaction and widely spreads the cast vote or rating vote through the blockchain network for verifying the cast vote or rating vote as a vote transaction when any voter casts the vote or the rating vote through the secret ballot smart contract or the rating vote smart contract, each of the validator nodes adds the verified cast votes or rating votes between the validator nodes among votes or rating votes that are voted for by the voters to a block, and each of the validator nodes performs consensus on a block including the verified cast votes or rating votes using a consensus algorithm between the validator nodes for adding a block reaching consensus as a new block to a blockchain.

19. The method according to claim 18, wherein respective weights of the plurality of candidates are determined by a number of responses through a client device with respect to at least one questionnaire task presented by the server.

20. The method according to claim 18, wherein the list of the voters is defined by including an appropriate number of members obtaining content from among members registered in the server.

21. The method according to claim 18, further comprising:
calculating a score of each of the candidates by multiplying a unique weight of each of the candidates by a number of votes obtained by each of the candidates as the voters vote; and
determining at least one winning candidate according to a high score ranking for the scores obtained by each of the candidates.
